(19) United States
(12) Patent Application Publication
(10) Pub. No.: US 2024/0231868 A9
(43) Pub. Date: Jul. 11, 2024

(54) MANAGEMENT OF DUPLICATIVE VIRTUAL MACHINE ENTRIES FOR A DATA MANAGEMENT SYSTEM

(71) Applicant: Rubrik, Inc., Palo Alto, CA (US)

(72) Inventors: Disheng Su, Santa Clara, CA (US); Feng Lu, Alameda County, CA (US)

(21) Appl. No.: 17/972,345

(22) Filed: Oct. 24, 2022

(51) Int. Cl. G06F 9/455

(52) U.S. Cl. CPC G06F 9/45558; G06F 2009/4557; G06F 2009/45595

(57) ABSTRACT

A data management system may include a first data management subsystem in communication with a virtual machine management system and a second data management subsystem in communication with the virtual machine management system. The data management system may identify a first group of virtual machines visible to the first data management subsystem and a second group of virtual machines visible to the second data management subsystem. The data management system may then determine that a virtual machine is included in both the first group of virtual machines and the second group of virtual machines, and may display, via at least one view of a user interface of the data management system, a single entry for the virtual machine based at least in part on determining that the virtual machine is included in both the first group of virtual machines and the second group of virtual machines.

### FIELD OF TECHNOLOGY

The present disclosure relates generally to database systems and data processing, and more specifically to management of duplicative virtual machine entries for a data management system.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a method for managing virtual machines system that supports management of duplicative virtual machine entries for a data management system in accordance with aspects of the present disclosure.

FIG. 2 illustrates an example of a computing system that supports management of duplicative virtual machine entries for a data management system in accordance with aspects of the present disclosure.

FIG. 3 illustrates an example of a computing system that supports management of duplicative virtual machine entries for a data management system in accordance with aspects of the present disclosure.

FIG. 4 illustrates an example of a process flow that supports management of duplicative virtual machine entries for a data management system in accordance with aspects of the present disclosure.

FIG. 5 shows a block diagram of an apparatus that supports management of duplicative virtual machine entries for a data management system in accordance with aspects of the present disclosure.

FIG. 6 shows a block diagram of a duplicate entry management component that supports management of duplicative virtual machine entries for a data management system in accordance with aspects of the present disclosure.

FIG. 7 shows a diagram of a system including a device that supports management of duplicative virtual machine entries for a data management system in accordance with aspects of the present disclosure.

FIGS. 8 through 11 show flowcharts illustrating methods that support management of duplicative virtual machine entries for a data management system in accordance with aspects of the present disclosure.

### DETAILED DESCRIPTION

Some cloud data storage services may support multi-node clustered storage architecture managed by a database management system. A data management system may include multiple data management subsystems (e.g., clusters of storage nodes). A virtual machine management system may host multiple virtual machines, and different ones of the virtual machines may be assigned to different data management subsystems within the data management system—e.g., a first group of virtual machines may be assigned to a first data management subsystem within the data management system, a second group of virtual machines may be assigned to a second data management subsystem within the data management system, and so on. In some examples, a database management system may support a virtual data store that is replicated across two or more geographically separated data centers, where each data center manages a set of hosts running one or more virtual machines.

However, although each individual data management subsystem within the data management system may manage only some of the virtual machines, all of the virtual machines hosted by the virtual machine management system may be visible to each of the data management subsystems. As used herein, a virtual machine being visible to a data management subsystem may refer to the data management system being aware that the virtual machine exists, being aware that the virtual machine is hosted by the virtual machine management system, or both. For example, if a virtual machine is visible to a data management subsystem, the data management subsystem may receive information regarding the virtual machine (e.g., from the virtual machine management system), such as a virtual machine identifier or other metadata or other information (e.g., status or other operational information) associated with the virtual machine. Correspondingly, a virtual machine being invisible to a data management subsystem may refer to the data management system not being aware that the virtual machine exists, not being aware that the virtual machine is hosted by the virtual machine management system, or both. For example, if a virtual machine is invisible to a data management subsystem, the data management subsystem may not receive information regarding the virtual machine (e.g., from the virtual machine management system), such as a virtual machine identifier or other metadata or other information (e.g., status or other operational information) associated with the virtual machine.

Because all of the virtual machines hosted by the virtual machine management system may be visible to each of the data management subsystems (even though each individual data management subsystem within the data management system may manage only some of the virtual machines), for the data management system as a whole (e.g., as displayed by a user interface for the data management system) there may be multiple virtual machine entries that each correspond to the same virtual machine. That is, there may be a first set of duplicative entries each representing a first virtual machine (with each of the duplicative entries in the first set corresponding to a different data management subsystem that has visibility of the first virtual machine), a second set of duplicative entries each representing a second virtual machine (with each of the duplicative entries in the second set corresponding to a different data management subsystem that has visibility of the first virtual machine), and so on. The duplicative entries may arise because, for an individual virtual machine, a corresponding entry may be generated for each of the multiple data management subsystems to which the individual virtual machine is visible, resulting in a set of duplicative entries for a virtual machine if the virtual machine is visible to multiple data management subsystems. Such duplicative entries may lead to excess (e.g., duplicative) operations or processing by the data management system, confusion for a user of the data management system, or any combination thereof, among other possible drawbacks.

To effectively manage duplicate entries of a virtual machine, one or more aspects of the present disclosure provides for deduplicating virtual machine entries at the data management system (as viewed via a user interface of the data management system) and managing a virtual machine that is visible to multiple data management subsystems. In some examples, a periodic backend job may identify which virtual machine entries are duplicative entries corresponding to the same virtual machine. Within a group of duplicative entries, the backend job identifies an active (e.g., primary) entry, which may be the entry corresponding to the data management subsystem that is actively managing the virtual machine (versus the other duplicative entries of the group, which correspond to other data management subsystems to which the virtual machine is visible, but which are not actively managing the virtual machine). The data management system may display to a user only a single entry for each virtual machine. For a virtual machine that is visible to multiple data management subsystems, an expandable menu may show those data management subsystems, along with an indication of the data management subsystem that is actively managing the virtual machine. Also, when initiating an operation associated with a virtual machine that is visible to multiple data management subsystems, a user may be allowed to choose a specific one of those data management subsystems for performing the operation.

Additionally, or alternatively, the present disclosure discusses one or more techniques for avoiding duplicative virtual machine entries at the data management system. A user of the data management system may be able to choose which data management subsystems to which a virtual machine is visible (e.g., when setting up one or more virtual machines for management by the data management system). This can avoid duplicative entries (e.g., if the user chooses only a single data management subsystem) or help proactively identify and manage duplicative entries as described herein. Thus, the techniques depicted herein may handle deduplication of virtual machine entries at the data management system.

Aspects of the disclosure are initially described in the context of an environment supporting an on-demand database service. Aspects of the disclosure are further described in the context of computing systems and process flow. Aspects of the disclosure are further illustrated by and described with reference to apparatus diagrams, system diagrams, and flowcharts that relate to management of duplicative virtual machine entries for a data management system.

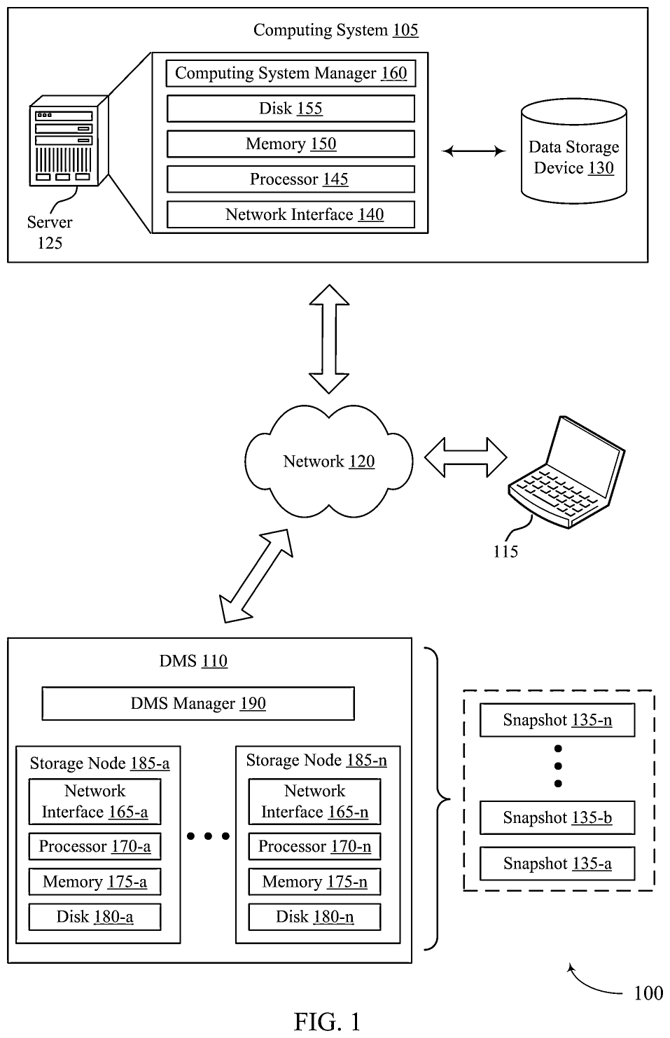

FIG. 1 illustrates an example of a computing environment 100 for cloud computing that supports techniques for using data backup and disaster recovery configurations for application management in accordance with various aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g. a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally or alternatively, the DMS 110 may detect whether aspects of the computing system 105 have been impacted by malware (e.g., ransomware). Additionally or alternatively, the DMS 110 may relocate data or create copies of data based on using one or more snapshots 135 to restore the associated computing object within its original location or at a new location (e.g., a new location within a different computing system 105). Additionally or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely.

According to one or more aspects depicted herein, the DMS 110 may include a first data management subsystem in communication with a virtual machine management system and a second data management subsystem in communication with the virtual machine management system. The DMS 110 may identify a first group of virtual machines visible to the first data management subsystem and a second group of virtual machines visible to the second data management subsystem. The DMS 110 may then determine that a virtual machine is included in both the first group of virtual machines and the second group of virtual machines, and may display, via at least one view of a user interface of the DMS 110, a single entry for the virtual machine based at least in part on determining that the virtual machine is included in both the first group of virtual machines and the second group of virtual machines.

In some examples, the DMS 110 may include a set of data management subsystems in communication with a virtual machine management system. The DMS 110 may identify a virtual machine associated with the virtual machine management system. The DMS 110 may receive, via a user interface of the DMS 110, an indication of a selection of a data management subsystem of the set of data management subsystems to have visibility of the virtual machine. The DMS 110 may then configure the selected data management subsystem to have visibility of the virtual machine in response to the indication of the selection of the data management subsystem being received via the user interface of the DMS 110.

It should be appreciated by a person skilled in the art that one or more aspects of the disclosure may be implemented in a computing environment 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

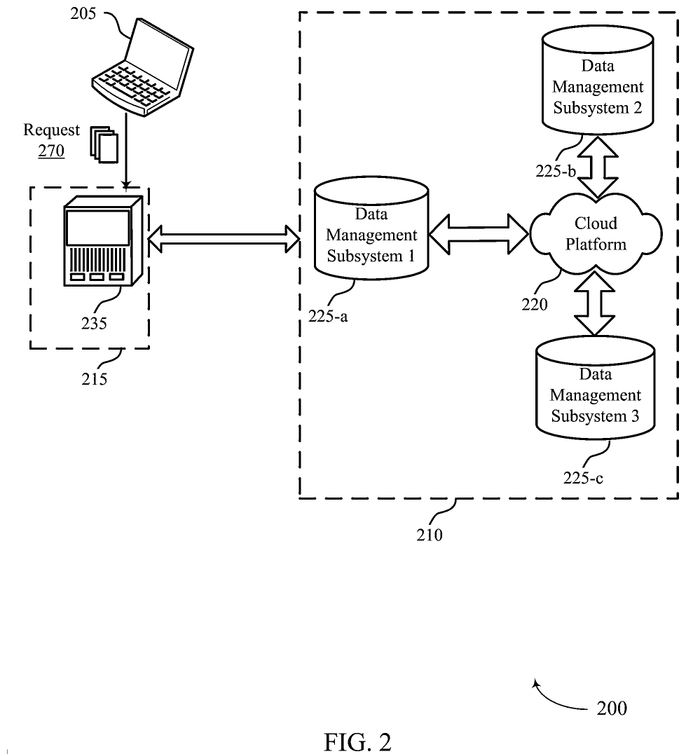

FIG. 2 illustrates an example of a computing system 200 that supports management of duplicative virtual machine entries for a data management system in accordance with aspects of the present disclosure. The computing system 200 includes a user device 205, a data management system 210 and a data manager 215. The data management system 210 may be a data storage infrastructure. The user device 205 may be an example of a device described with reference to FIG. 1. The user device 205 may also be an example of a cloud client. A cloud client may access data sources using a network connection. The network may implement transfer control protocol and internet protocol (TCP/IP), such as the Internet, or may implement other network protocols. The user device 205 may be an example of a user device, such as a server, a smartphone, or a laptop. In other examples, a user device 205 may be a desktop computer, a tablet, a sensor, or another computing device or system capable of generating, analyzing, transmitting, or receiving communications. In some examples, the user device 205 may be operated by a user that is part of a business, an enterprise, a non-profit, a startup, or any other organization type.

The data management system 210 may include a first data management subsystem 225-a (e.g., first data center), a second data management subsystem 225-b, and a third data management subsystem 225-c. Although not depicted herein, the data management system 210 may include more than three data management subsystems 225. The data management subsystems 225 may be geographically separated from each other. As depicted in the example of FIG. 2, the data management system 210 may include a cloud platform 220. The cloud platform 220 may offer an on-demand storage and computing services to the user device 205. In some cases, the data management system 210 may be an example of a storage system with built-in data management. The data management system 210 may serve multiple users with a single instance of software. However, other types of systems may be implemented, including—but not limited to—client-server systems, mobile device systems, and mobile network systems. The data manager 215 may be an example of an integrated data management and storage system. The data manager 215 may include an application server 235. The application server 235 may represent a unified storage system even though numerous storage nodes may be connected together and the number of connected storage nodes may change over time as storage nodes are added or removed. The data manager 215 may also be an example of a cloud-based storage and an on-demand computing platform.

As depicted herein, the computing system 200 may support an integrated data management and storage system and may be configured to manage the automated storage, backup, deduplication, replication, recovery, and archival of data within and across physical and virtual computing environments. The computing system 200 including an integrated data management and storage system may provide a unified primary and secondary storage system with built-in data management that may be used as both a backup storage system and a “live” primary storage system for primary workloads. In some cases, the integrated data management and storage system may manage dynamic versions when performing data storage. In some examples, the computing system 200 may provide backup of data (e.g., one or more files) using parallelized workloads, where the data may reside on virtual machines and/or real machines (e.g., a hardware server, a laptop, a tablet computer, a smartphone, or a mobile computing device).

According to aspects depicted herein, the computing system 200 supports multiple data centers running in a clustered setup. A user may transmit a request 270 to geo-replicate a virtual data storage infrastructure. The data management system 210 may include or otherwise support a primary storage replicated to multiple data centers. In such a setup, the customer (e.g., user of the user device 205) may request 270 a customer data management to be replicated to multiple data centers. Utilizing the techniques depicted herein, the computing system 200 may manage deduplication of duplicative virtual machine entries.

A first data management subsystem 225-a may support a first data management platform and a second data management subsystem 225-b may support a second data management platform. To effectively support virtual machine deduplication, the computing system 200 may support calculating and recording duplicate virtual machine information within the data management system 210 that includes a first data management subsystem 225-a (data management subsystem 1) and a second data management subsystem 225-b (data management subsystem 2) that is geographically separated from the first data management subsystem 225-a.

In some examples, customers may often connect the same virtual data storage infrastructure to multiple data management subsystems. A virtual machine on such a virtual data storage infrastructure may be displayed as multiple entries in an inventory page for the virtual data storage infrastructure. Such entries for the virtual machine include one entry for each cluster (or data management subsystems) that has the virtual machine visible. In such cases, the virtual machine instances may be designated as duplicates of one unique virtual machine. Such duplicate virtual machine instances displays may cause confusion and add complexity for customers to find, protect, and recover a virtual machine. Second, having duplicate virtual machine entries may be difficult for a customer to assign a service level agreement to one virtual machine on no more than one data management subsystem at once. Techniques depicted herein provide for deduplicating virtual machine instances such that a single instance is displayed via at least one user interface for a unique virtual machine.

The computing system 200 may support a periodic backend job that calculates and records the duplicate virtual machine information in the data management system 210. The information includes which virtual machine instances belong to the same unique virtual machine and which virtual machine is the active (or primary) member within the group. The computing system 200 may also provide for linking virtual machines across different data centers. In some examples, the application server 235 may configure the data management system 210 to replicate a full snapshot and one or more incremental snapshots of a virtual machine from the first data management platform corresponding to data management subsystem 225-a to the second data management platform corresponding to data management subsystem 225-b. In some examples, the data management system 210 may include a first data management subsystem 225-a in communication with a virtual machine management system (e.g., application server 235) and a second data management subsystem 225-b in communication with the virtual machine management system. The first data management subsystem 225-a may include a first cluster of storage nodes and the second data management subsystem 225-b may include a second cluster of storage nodes. The data management system 210 may identify a first group of virtual machines visible to the first data management subsystem 225-a and a second group of virtual machines visible to the second data management subsystem 225-b.

The data management system 210 may determine that a virtual machine is included in both the first group of virtual machines and the second group of virtual machines. In some examples, the data management system 210 may initiate a periodic backend job to determine that that the virtual machine is included in both the first group of virtual machines and the second group of virtual machines. In some examples, the data management system 210 may determine that a first group of virtual machine identifiers associated with the first group of virtual machines and a second group of virtual machine identifiers associated with the second group of virtual machines both include a virtual machine identifier associated with the virtual machine. In such cases, the data management system 210 may choose to display, via at least one view of a user interface of the data management system 210, a single entry for the virtual machine.

The single entry of for the virtual machine (e.g., the virtual machine that is replicated across multiple data management subsystems) may correspond to an active member (or active virtual machine). The active member may default to a virtual machine having an active protection service level agreement. In some instances, the active member may refer to the first virtual machine that the periodic backend job finds in the group if no member has a protection service level agreement. For example, the data management system 210 may determine a first entry for the virtual machine corresponding to the first group of virtual machines and a second entry for the virtual machine corresponding to the second group of virtual machines. The data management system 210 may also determine that one of the first entry or the second entry corresponds to an active entry of the virtual machine. In such cases, displaying the single entry for the virtual machine may include displaying the active entry for the virtual machine. Additionally, or alternatively, the data management system 210 may identify, in response to determining the first entry and the second entry, a first set of configurations associated with the first entry for the virtual machine and a second set of configurations associated with the second entry for the virtual machine. The data management system 210 may determine that the one of the first entry or the second entry corresponds to an active entry of the virtual machine based on the first set of configurations and the second set of configurations. In some cases, one of the first set of configurations or the second set of configurations includes an active service level agreement and. the active entry is associated with the one of the first set of configurations or the second set of configurations that includes the active service level agreement. Thus, the data management system 210 may utilize the information regarding the active virtual machine entry when displaying an instance of the virtual machine.

For virtual machine entries with duplicates, techniques depicted herein provide for display of one entry per unique virtual machine, while an expandable clickable on this entry may display which data management subsystem of the set data management subsystems has this virtual machine visible. Additionally, or alternatively, the expanded view may indicate which data management subsystem 225 has a service level agreement assigned. For example, the data management system 210 may provide for displaying, via a second view of the user interface of the data management system 210, an expansion of the single entry for the virtual machine including an indication of the first data management subsystem 225-a and the second data management subsystem 225-b. Additionally, or alternatively, the data management system 210 may provide for displaying, via a second view of the user interface of the data management system 210, an expansion of the single entry for the virtual machine comprising an indication of a data management subsystem 225 that is actively managing the virtual machine.

According to one or more aspects depicted herein, the computing system 200 may support virtual machine protection and recovery. A customer (e.g., a user using user device 205) may initiate an operation (via request 270). When initiating the operation (e.g., take on demand snapshot, manage protection, live mount, etc.) and after selecting some inventory with duplicates, the data management system 210 may support display of an additional step to allow customers to choose a specific data management subsystem 225 to perform the operation on. In some examples, a dropdown menu allows customers to switch between data management subsystems 225 that a particular virtual machine is visible to. For example, the data management system 210 may receive, via a second view of the user interface of the data management system 210, a user input to select the first data management subsystem 225-a or the second data management subsystem 225-b for one or more operations. According to aspects depicted herein, the one or more operations may include at least one of capturing an on-demand snapshot, managing protection of a set of virtual machines, initiating a live mount, or a combination thereof. Thus, the customers may then perform operations on the selected data management subsystem 225 (the data management subsystem 225 the customers select after switching).

In some examples, techniques depicted herein provide for management of virtual machine resources. In such cases, the data management system 210 may provide for adding a flow (e.g., “Set compute resources visibility” flow) to a set of virtual machine management option available to a customer. This is to help customers define which data management subsystems 225 may have a virtual machine visible. For example, the data management system 210 may include a set of data management subsystems 225 in communication with a virtual machine management system. The data management system 210 may identify a virtual machine associated with the virtual machine management system. Based on the flow displayed at a user device 205, the data management system 210 may receive, via a user interface of the data management system 210, an indication of a selection of a data management subsystem 225-a of the set of data management subsystems 225 to have visibility of the virtual machine. The data management system 210 may configure the selected data management subsystem 225-a to have visibility of the virtual machine in response to the indication of the selection of the data management subsystem 225-a being received via the user interface of the data management system 210. In such cases, another data management subsystem 225-b of the set of data management subsystems 225 does not have visibility of the virtual machine based on not being the selected data management subsystem 225-a.

Additionally, or alternatively, the data management system 210 may receive, via the user interface of the data management system 210, an indication of a selection of a second data management subsystem 225-c of the set of data managements subsystems 225 to have visibility of the virtual machine. In such cases, the data management system 210 may configure the second data management subsystem 225-c to have visibility of the virtual machine in response to the indication of the selection of the second data management subsystem 225-c being received via the user interface of the data management system 210. The data management system 210 may receive an indication of a selection of a group of data management subsystems to have visibility of the virtual machine, the group of data management subsystems including the data management subsystem 225-a and the second data management subsystem 225-c. Thus, the customer may configure the data management subsystem 225-a and the data management subsystem 225-c to have visibility of a virtual machine and the data management subsystem 225-b to not have visibility of the virtual machine. Thus, the techniques depicted herein effectively reduces virtual machine duplicates when a virtual machine has been connected to multiple data management subsystems.

According to the deduplication process depicted herein, the computing system 200 may support techniques for resolving service level agreement conflicts. It may be possible that a virtual machine has been protected by two separate data management subsystems. The computing system 200 may provide a button and workflow to resolve the service level agreement conflicts in such cases. For instance, the computing system 200 may ensure that one data management subsystem retains the service level agreement for a particular virtual machine; while the others stop protection on the virtual machine (the previously captured snapshots may continue to retain previous service level agreement). In some examples, the computing system 200 may support informing customers of relic snapshots after a service level agreement conflict was resolved. For example, the customer may manage the number of snapshots that are displayed in the inventory entry (e.g., the customer may choose to exclude previous snapshots from the display).

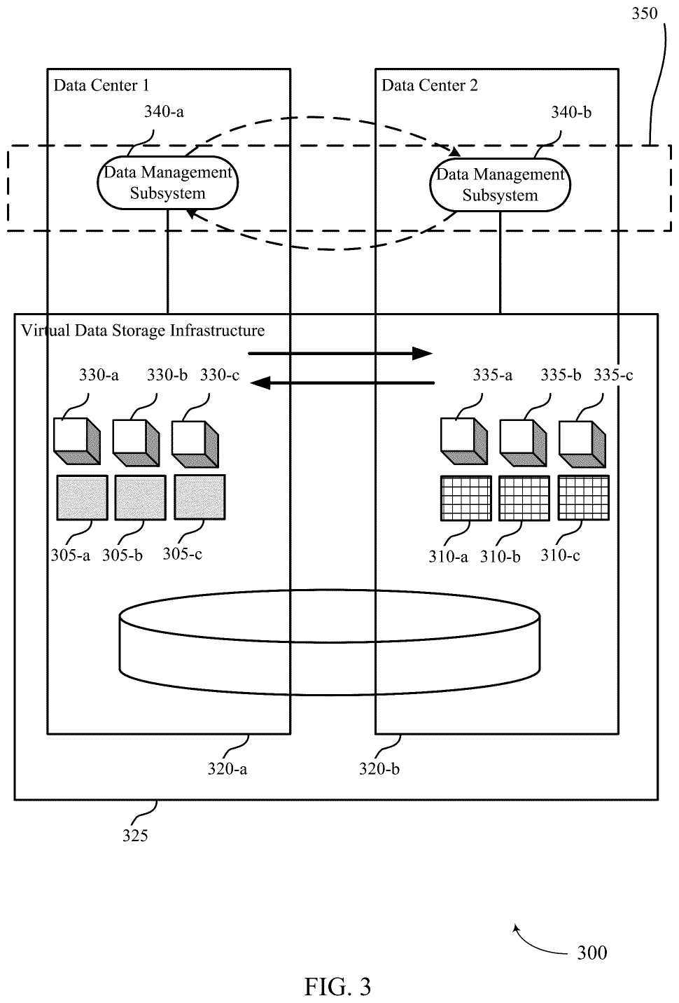

FIG. 3 illustrates an example of a computing system 300 that supports management of duplicative virtual machine entries for a data management system in accordance with aspects of the present disclosure. The computing system 300 includes a virtual machine management system 325. The virtual machine management system 325 may be configured such that it is deployed across multiple data centers, such as a first data center 320-a and a second data center 320-b. The second data center 320-b may be geographically separated from the first data center 320-a.

The virtual machine management system 325 includes a first set of hosts 330 (330-a, 330-b, and 330-c) associated with the first data center 320-a and a second set of hosts 335 (335-a, 335-b, and 335-c) associated with the second data center 320-b. In some examples, a database may be configured as a set of database instances running on a set of virtual machines 305 on the first data center 320-a and a set of virtual machines 310 on the second data center 320-b. The virtual machine management system 325 may be an example of the virtual machine management system described with reference to FIG. 2. The first data center 320-a may include or otherwise be associated with a first data management subsystem 340-a, and the second data center 320-b may include or otherwise be associated with a second data management subsystem 340-b. The two data management subsystems may both be part of a data management system 350.

As depicted in the example of FIG. 3, the virtual machine management system 325 (and hence the data management system 350) may span multiple datacenters. In such an architecture, workloads may dynamically move between the two data centers (and in case of a disaster, one data center may take over transparently the whole workload). The first data center 320-a may support a first set of virtual machines 305 (305-a, 305-b, and 305-c) and the second data center 320-b may support a second set of virtual machines 310 (310-a, 310-b, and 310-c). Every virtual machine may have a local side that is enforced by a set of rules (e.g., virtual machine or host soft affinity rules).

The first data management subsystem 340-a and the second data management subsystem 340-b may both be in communication with the virtual machine management system 325. Thus, the first group of virtual machines 305-a, 305-b, 305-c may be visible to both the first data management subsystem 340-a and the second data management subsystem 340-b. This may cause the data management system 350 to identify duplicative entries for each virtual machine 305 in the first group of virtual machines 305-a, 305-b, 305-c (e.g., for each virtual machine 305, the data management system 350 may identify two duplicative entries, one for the virtual machine 305 as visible to the first data management subsystem 340-a and another for the same virtual machine 305 as visible to the second data management subsystem 340-b). Similarly, the second group of virtual machines 310-a, 310-b, and 310-c may be visible to both the first data management subsystem 340-a and the second data management subsystem 340-b, which may cause the data management system 350 to identify duplicative entries for each virtual machine 310 in the second group of virtual machines 310-a, 310-b, 310-c (e.g., for each virtual machine 310, the data management system 350 may identify two duplicative entries, one for the virtual machine 310 as visible to the first data management subsystem 340-a and another for the same virtual machine 310 as visible to the second data management subsystem 340-b).

In such cases, using techniques as described herein, the data management system 325 may display (within at least one view of a user interface), for each virtual machine 305 or virtual machine 310, a single corresponding entry 315. That is, the data management system 325 may deduplicate entries that may be generated for the same virtual machine 305 or the same virtual machine 310, just as seen by different data management subsystems 340. Additionally, or alternatively, the data management system 325 may receive, via a user interface of the data management system 350, an indication of a selection of a data management subsystem 340 to have visibility of a virtual machine virtual machine 305 or virtual machine 310 (e.g., as part of a configuration process for the virtual machine management system 325 or the data management system 350), and only the selected data management subsystem 340 (or selected group of data management subsystems 340) may have visibility of that virtual machine 305 or virtual machine 310, while one or more other data management subsystems 340 within the data management system 350 do not have visibility of the virtual machine 305 or virtual machine 310—this may prevent duplicative entries for a virtual machine 305 or virtual machine 310 being generated or otherwise arising, which may in some cases obviate the need for associated deduplication or other remedial techniques. For example, the data management system 325 may configure the first data management subsystem 340-a to have visibility of the virtual machine 305-c (and for the second data management subsystem 340-b to not have visibility of the virtual machine 305-c) in response to an indication of the selection of the first data management subsystem 340-a being received via a user interface of the data management system 350.

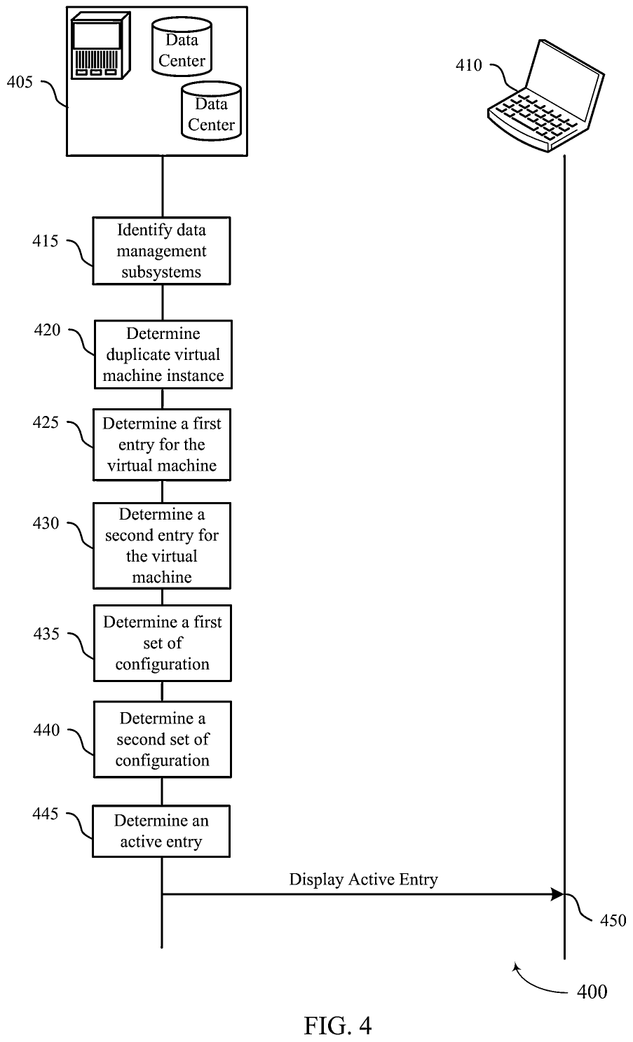

FIG. 4 illustrates an example of a process flow 400 that supports management of duplicative virtual machine entries for a data management system in accordance with aspects of the present disclosure. The process flow 400 includes a data management platform 405 and a user device 410. The data management platform 405 may include an application server, a metadata storage and multiple data centers of a computing cluster as described with respect to FIGS. 2 and 3. The data management platform 405 may include a first data management subsystem in communication with a virtual machine management system and a second data management subsystem in communication with the virtual machine management system. The user device 410 may be an example of a user device as described with respect to FIGS. 2 and 3. Although a single entity is depicted as data management platform 405, it may be understood that components of the data management platform 405 may be located in different locations.

In some examples, the operations illustrated in the process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 415, the data management platform 405 may identify a first group of virtual machines visible to the first data management subsystem and a second group of virtual machines visible to the second data management subsystem.

At 420, the data management platform 405 may determine that a virtual machine is included in both the first group of virtual machines and the second group of virtual machines. At 425, the data management platform 405 may determine a first entry for the virtual machine corresponding to the first group of virtual machines and a second entry for the virtual machine corresponding to the second group of virtual machines.

At 430, the data management platform 405 may determine that one of the first entry or the second entry corresponds to an active entry of the virtual machine. In some examples, displaying the single entry for the virtual machine may include displaying the active entry for the virtual machine.

At 435, the data management platform 405 may identify in response to determining the first entry and the second entry, a first set of configurations associated with the first entry for the virtual machine. At 440, the data management platform 405 may identify, in response to determining the first entry and the second entry, a second set of configurations associated with the second entry for the virtual machine. In some examples, determining that the one of the first entry or the second entry corresponds to an active entry of the virtual machine is based on the first set of configurations and the second set of configurations.

At 445, the data management platform 405 may identify an active entry for the virtual machine. In some examples, one of the first set of configurations or the second set of configurations includes an active service level agreement. The active entry may be associated with the one of the first set of configurations or the second set of configurations that includes the active service level agreement.

At 450, the data management platform 405 may display, via at least one view of a user interface of the data management system, a single entry for the virtual machine based on determining that the virtual machine is included in both the first group of virtual machines and the second group of virtual machines.

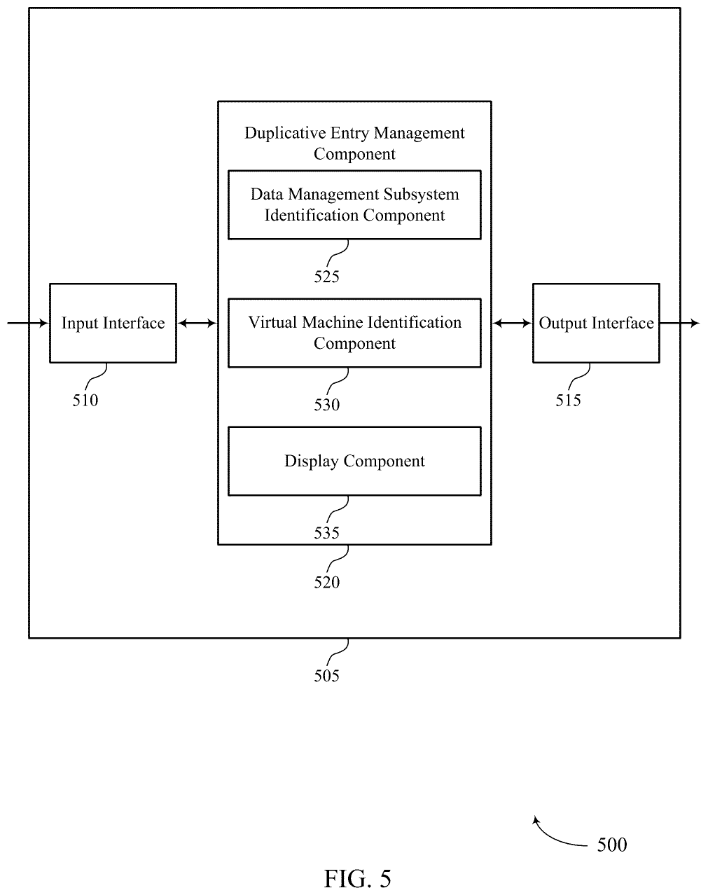

FIG. 5 shows a block diagram 500 of a system 505 that supports management of duplicative virtual machine entries for a data management system in accordance with aspects of the present disclosure. The system 505 may be an example of aspects of one or more components described with reference to FIG. 1, such as a DMS 110. The system 505 may include an input interface 510, an output interface 515, and a duplicate entry management component 520. The system 505 may also include one or more processors. Each of these components may be in communication with one another (e.g., via one or more buses, communications links, communications interfaces, or any combination thereof).

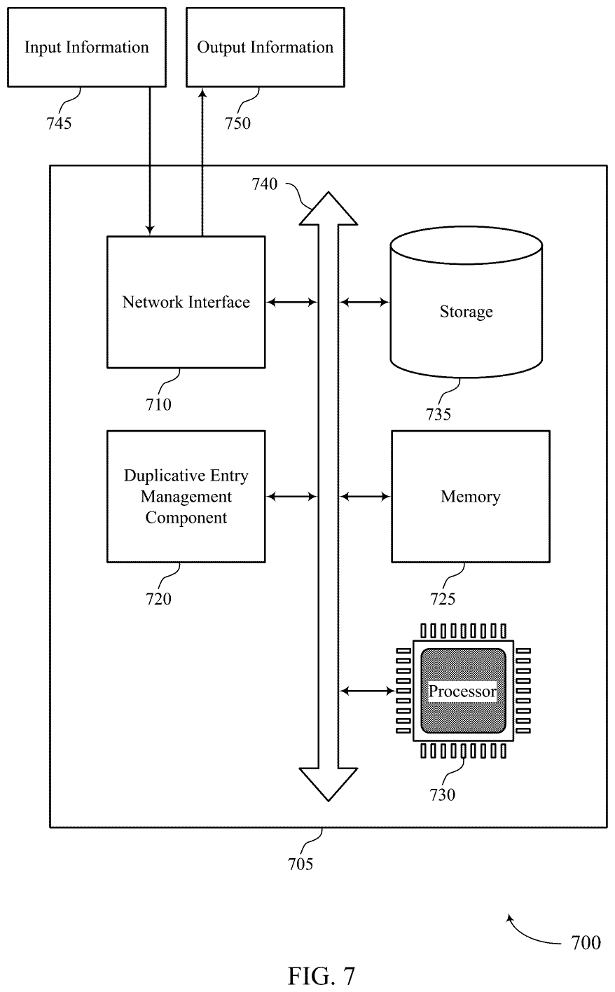

The input interface 510 may manage input signals for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the duplicate entry management component 520 to support management of duplicative virtual machine entries for a data management system. In some cases, the input interface 510 may be a component of a network interface 710 as described with reference to FIG. 7.

The output interface 515 may manage output signaling for the system 505. For example, the output interface 515 may receive signals from other components of the system 505, such as the duplicate entry management component 520, and may transmit such output signaling corresponding to (e.g., representative of or otherwise based on) such signaling to other systems or devices. In some cases, the output interface 515 may be a component of a network interface 710 as described with reference to FIG. 7.

For example, the duplicate entry management component 520 may include a data management subsystem identification component 525, a virtual machine identification component 530, a display component 535, or any combination thereof. In some examples, the duplicate entry management component 520, or various components thereof, may be configured to perform various operations (e.g., receiving, monitoring, transmitting) using or otherwise in cooperation with the input interface 510, the output interface 515, or both. For example, the duplicate entry management component 520 may receive information from the input interface 510, send information to the output interface 515, or both to receive information, transmit information, or perform various other operations as described herein.

The duplicate entry management component 520 may support managing virtual machines in accordance with examples as disclosed herein. The data management subsystem identification component 525 may be configured as or otherwise support a means for identifying, at a data management system that includes a first data management subsystem in communication with a virtual machine management system and a second data management subsystem in communication with the virtual machine management system, a first group of virtual machines visible to the first data management subsystem and a second group of virtual machines visible to the second data management subsystem. The virtual machine identification component 530 may be configured as or otherwise support a means for determining, by the data management system, that a virtual machine is included in both the first group of virtual machines and the second group of virtual machines. The display component 535 may be configured as or otherwise support a means for displaying, via at least one view of a user interface of the data management system, a single entry for the virtual machine based on determining that the virtual machine is included in both the first group of virtual machines and the second group of virtual machines.

Additionally, or alternatively, the duplicate entry management component 520 may support managing virtual machines in accordance with examples as disclosed herein. The data management subsystem identification component 525 may be configured as or otherwise support a means for identifying, at a data management system that includes a set of multiple data management subsystems in communication with a virtual machine management system, a virtual machine associated with the virtual machine management system. The data management subsystem identification component 525 may be configured as or otherwise support a means for receiving, via a user interface of the data management system, an indication of a selection of a data management subsystem of the set of multiple data management subsystems to have visibility of the virtual machine. The display component 535 may be configured as or otherwise support a means for configuring, by the data management system, the selected data management subsystem to have visibility of the virtual machine in response to the indication of the selection of the data management subsystem being received via the user interface of the data management system.

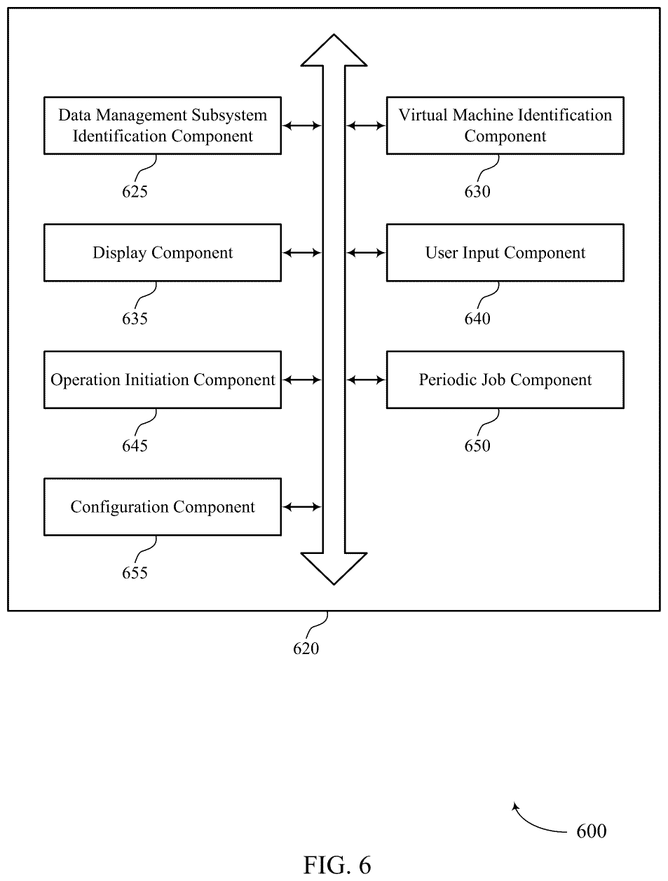

FIG. 6 shows a block diagram 600 of a duplicate entry management component 620 that supports management of duplicative virtual machine entries for a data management system in accordance with aspects of the present disclosure. The duplicate entry management component 620 may be an example of aspects of a duplicate entry management component or a duplicate entry management component 520, or both, as described herein. The duplicate entry management component 620, or various components thereof, may be an example of means for performing various aspects of management of duplicative virtual machine entries for a data management system as described herein. For example, the duplicate entry management component 620 may include a data management subsystem identification component 625, a virtual machine identification component 630, a display component 635, a user input component 640, an operation initiation component 645, a periodic job component 650, a configuration component 655, or any combination thereof. Each of these components may communicate, directly or indirectly, with one another (e.g., via one or more buses).

The duplicate entry management component 620 may support managing virtual machines in accordance with examples as disclosed herein. The data management subsystem identification component 625 may be configured as or otherwise support a means for identifying, at a data management system that includes a first data management subsystem in communication with a virtual machine management system and a second data management subsystem in communication with the virtual machine management system, a first group of virtual machines visible to the first data management subsystem and a second group of virtual machines visible to the second data management subsystem. The virtual machine identification component 630 may be configured as or otherwise support a means for determining, by the data management system, that a virtual machine is included in both the first group of virtual machines and the second group of virtual machines. The display component 635 may be configured as or otherwise support a means for displaying, via at least one view of a user interface of the data management system, a single entry for the virtual machine based on determining that the virtual machine is included in both the first group of virtual machines and the second group of virtual machines.

In some examples, the display component 635 may be configured as or otherwise support a means for determining, for the user interface, a first entry for the virtual machine corresponding to the first group of virtual machines and a second entry for the virtual machine corresponding to the second group of virtual machines. In some examples, the display component 635 may be configured as or otherwise support a means for determining that one of the first entry or the second entry corresponds to an active entry of the virtual machine, where displaying the single entry for the virtual machine includes displaying the active entry for the virtual machine.

In some examples, the configuration component 655 may be configured as or otherwise support a means for identifying, in response to determining the first entry and the second entry, a first set of configurations associated with the first entry for the virtual machine and a second set of configurations associated with the second entry for the virtual machine, where determining that the one of the first entry or the second entry corresponds to an active entry of the virtual machine is based on the first set of configurations and the second set of configurations.

In some examples, one of the first set of configurations or the second set of configurations includes an active service level agreement. In some examples, the active entry is associated with the one of the first set of configurations or the second set of configurations that includes the active service level agreement.

In some examples, the display component 635 may be configured as or otherwise support a means for displaying, via a second view of the user interface of the data management system, an expansion of the single entry for the virtual machine including an indication of the first data management subsystem and the second data management subsystem.

In some examples, the display component 635 may be configured as or otherwise support a means for displaying, via a second view of the user interface of the data management system, an expansion of the single entry for the virtual machine including an indication of a data management subsystem that is actively managing the virtual machine.

In some examples, the user input component 640 may be configured as or otherwise support a means for receiving, via a second view of the user interface of the data management system, a user input to select the first data management subsystem or the second data management subsystem for one or more operations. In some examples, the operation initiation component 645 may be configured as or otherwise support a means for initiating the one or more operations on the selected data management subsystem in response to receiving the user input.

In some examples, the one or more operations include at least one of capturing an on-demand snapshot, managing protection of a set of multiple virtual machines, initiating a live mount, or a combination thereof.

In some examples, the periodic job component 650 may be configured as or otherwise support a means for initiating a periodic backend job to determine that that the virtual machine is included in both the first group of virtual machines and the second group of virtual machines. In some examples, to support determining that the virtual machine is included in both the first group of virtual machines and the second group of virtual machines, the virtual machine identification component 630 may be configured as or otherwise support a means for determining that a first group of virtual machine identifiers associated with the first group of virtual machines and a second group of virtual machine identifiers associated with the second group of virtual machines both include a virtual machine identifier associated with the virtual machine.

In some examples, the first data management subsystem includes a first cluster of storage nodes, and the second data management subsystem includes a second cluster of storage nodes.

Additionally, or alternatively, the duplicate entry management component 620 may support managing virtual machines in accordance with examples as disclosed herein. In some examples, the data management subsystem identification component 625 may be configured as or otherwise support a means for identifying, at a data management system that includes a set of multiple data management subsystems in communication with a virtual machine management system, a virtual machine associated with the virtual machine management system. In some examples, the data management subsystem identification component 625 may be configured as or otherwise support a means for receiving, via a user interface of the data management system, an indication of a selection of a data management subsystem of the set of multiple data management subsystems to have visibility of the virtual machine. In some examples, the display component 635 may be configured as or otherwise support a means for configuring, by the data management system, the selected data management subsystem to have visibility of the virtual machine in response to the indication of the selection of the data management subsystem being received via the user interface of the data management system. In some examples, another data management subsystem of the set of multiple data management subsystems does not have visibility of the virtual machine based on not being the selected data management subsystem.

In some examples, the user input component 640 may be configured as or otherwise support a means for receiving, via the user interface of the data management system, an indication of a selection of a second data management subsystem of the set of multiple data managements subsystems to have visibility of the virtual machine. In some examples, the configuration component 655 may be configured as or otherwise support a means for configuring, by the data management system, the second data management subsystem to have visibility of the virtual machine in response to the indication of the selection of the second data management subsystem being received via the user interface of the data management system.

In some examples, to support receiving the indication of the selection of the data management subsystem and receiving the indication of the selection of the second data management subsystem, the data management subsystem identification component 625 may be configured as or otherwise support a means for receiving an indication of a selection of a group of data management subsystems to have visibility of the virtual machine, the group of data management subsystems including the data management subsystem and the second data management subsystem.

In some examples, the set of multiple data management subsystems include a set of multiple clusters of storage nodes.

FIG. 7 shows a diagram of a system 700 including a device 705 that supports management of duplicative virtual machine entries for a data management system in accordance with aspects of the present disclosure. The device 705 may be an example of or include the components of a system 505 as described herein. The device 705 may include components for bi-directional data communications including components for transmitting and receiving communications, such as a duplicate entry management component 720, a network interface 710, a memory 725, a processor 730, and a storage 735. These components may be in electronic communication or otherwise coupled (e.g., operatively, communicatively, functionally, electronically, electrically) via one or more buses (e.g., a bus 740).

The network interface 710 may manage input information 745 and output information 750 for the device 705. The network interface 710 may also manage peripherals not integrated into the device 705. In some cases, the network interface 710 may represent a physical connection or port to an external peripheral. In some cases, the network interface 710 may utilize an operating system such as iOS®, ANDROID®, MS-DOS®, MS-WINDOWS®, OS/2®, UNIX®, LINUX®, or another known operating system. In other cases, the network interface 710 may represent or interact with a modem, a keyboard, a mouse, a touchscreen, or a similar device. In some cases, the network interface 710 may be implemented as part of a processor 730. In some examples, a user may interact with the device 705 via the network interface 710 or via hardware components controlled by the network interface 710. The storage 735 may be an example of a single database, a distributed database, multiple distributed databases, a data store, a data lake, or an emergency backup database.

Memory 725 may include random-access memory (RAM) and ROM. The memory 725 may store computer-readable, computer-executable software including instructions that, when executed, cause the processor 730 to perform various functions described herein. In some cases, the memory 725 may contain, among other things, a BIOS which may control basic hardware or software operation such as the interaction with peripheral components or devices.

The processor 730 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting management of duplicative virtual machine entries for a data management system).

The duplicate entry management component 720 may support managing virtual machines in accordance with examples as disclosed herein. For example, the duplicate entry management component 720 may be configured as or otherwise support a means for identifying, at a data management system that includes a first data management subsystem in communication with a virtual machine management system and a second data management subsystem in communication with the virtual machine management system, a first group of virtual machines visible to the first data management subsystem and a second group of virtual machines visible to the second data management subsystem. The duplicate entry management component 720 may be configured as or otherwise support a means for determining, by the data management system, that a virtual machine is included in both the first group of virtual machines and the second group of virtual machines. The duplicate entry management component 720 may be configured as or otherwise support a means for displaying, via at least one view of a user interface of the data management system, a single entry for the virtual machine based on determining that the virtual machine is included in both the first group of virtual machines and the second group of virtual machines.

Additionally, or alternatively, the duplicate entry management component 720 may support managing virtual machines in accordance with examples as disclosed herein. For example, the duplicate entry management component 720 may be configured as or otherwise support a means for identifying, at a data management system that includes a set of multiple data management subsystems in communication with a virtual machine management system, a virtual machine associated with the virtual machine management system. The duplicate entry management component 720 may be configured as or otherwise support a means for receiving, via a user interface of the data management system, an indication of a selection of a data management subsystem of the set of multiple data management subsystems to have visibility of the virtual machine. The duplicate entry management component 720 may be configured as or otherwise support a means for configuring, by the data management system, the selected data management subsystem to have visibility of the virtual machine in response to the indication of the selection of the data management subsystem being received via the user interface of the data management system.

By including or configuring the duplicate entry management component 720 in accordance with examples as described herein, the device 705 may support techniques for deduplicating virtual machine entries for a data management system.

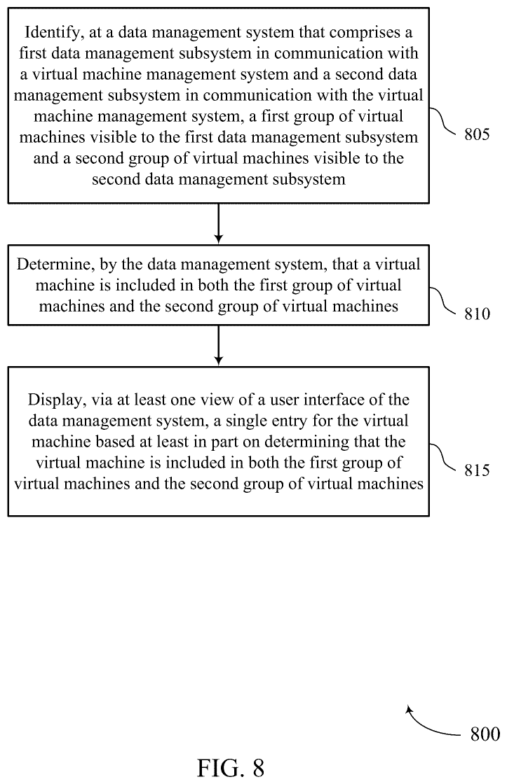

FIG. 8 shows a flowchart illustrating a method 800 that supports management of duplicative virtual machine entries for a data management system in accordance with aspects of the present disclosure. The operations of the method 800 may be implemented by a data manager or its components as described herein. For example, the operations of the method 800 may be performed by a data manager as described with reference to FIGS. 1 through 7. In some examples, a data manager may execute a set of instructions to control the functional elements of the data manager to perform the described functions. Additionally, or alternatively, the data manager may perform aspects of the described functions using special-purpose hardware.

At 805, the method may include identifying, at a data management system that includes a first data management subsystem in communication with a virtual machine management system and a second data management subsystem in communication with the virtual machine management system, a first group of virtual machines visible to the first data management subsystem and a second group of virtual machines visible to the second data management subsystem. The operations of 805 may be performed in accordance with examples as disclosed herein. In some examples, aspects of the operations of 805 may be performed by a data management subsystem identification component 625 as described with reference to FIG. 6.

At 810, the method may include determining, by the data management system, that a virtual machine is included in both the first group of virtual machines and the second group of virtual machines. The operations of 810 may be performed in accordance with examples as disclosed herein. In some examples, aspects of the operations of 810 may be performed by a virtual machine identification component 630 as described with reference to FIG. 6.

At 815, the method may include displaying, via at least one view of a user interface of the data management system, a single entry for the virtual machine based on determining that the virtual machine is included in both the first group of virtual machines and the second group of virtual machines. The operations of 815 may be performed in accordance with examples as disclosed herein. In some examples, aspects of the operations of 815 may be performed by a display component 635 as described with reference to FIG. 6.

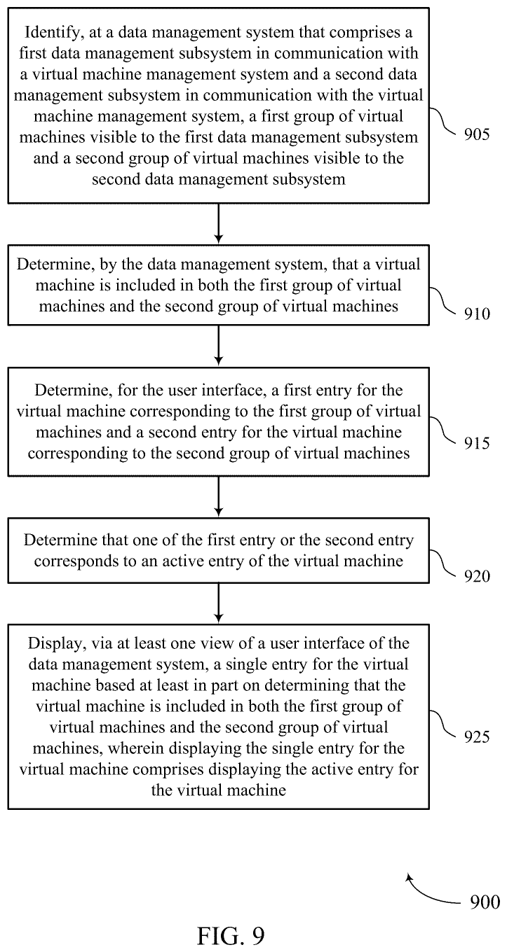

FIG. 9 shows a flowchart illustrating a method 900 that supports management of duplicative virtual machine entries for a data management system in accordance with aspects of the present disclosure. The operations of the method 900 may be implemented by a data manager or its components as described herein. For example, the operations of the method 900 may be performed by a data manager as described with reference to FIGS. 1 through 7. In some examples, a data manager may execute a set of instructions to control the functional elements of the data manager to perform the described functions. Additionally, or alternatively, the data manager may perform aspects of the described functions using special-purpose hardware.

At 905, the method may include identifying, at a data management system that includes a first data management subsystem in communication with a virtual machine management system and a second data management subsystem in communication with the virtual machine management system, a first group of virtual machines visible to the first data management subsystem and a second group of virtual machines visible to the second data management subsystem. The operations of 905 may be performed in accordance with examples as disclosed herein. In some examples, aspects of the operations of 905 may be performed by a data management subsystem identification component 625 as described with reference to FIG. 6.

At 910, the method may include determining, by the data management system, that a virtual machine is included in both the first group of virtual machines and the second group of virtual machines. The operations of 910 may be performed in accordance with examples as disclosed herein. In some examples, aspects of the operations of 910 may be performed by a virtual machine identification component 630 as described with reference to FIG. 6.

At 915, the method may include determining, for the user interface, a first entry for the virtual machine corresponding to the first group of virtual machines and a second entry for the virtual machine corresponding to the second group of virtual machines. The operations of 915 may be performed in accordance with examples as disclosed herein. In some examples, aspects of the operations of 915 may be performed by a display component 635 as described with reference to FIG. 6.

At 920, the method may include determining that one of the first entry or the second entry corresponds to an active entry of the virtual machine. The operations of 920 may be performed in accordance with examples as disclosed herein. In some examples, aspects of the operations of 920 may be performed by a display component 635 as described with reference to FIG. 6.

At 915, the method may include displaying, via at least one view of a user interface of the data management system, a single entry for the virtual machine based on determining that the virtual machine is included in both the first group of virtual machines and the second group of virtual machines, where displaying the single entry for the virtual machine comprises displaying the active entry for the virtual machine. The operations of 915 may be performed in accordance with examples as disclosed herein. In some examples, aspects of the operations of 915 may be performed by a display component 635 as described with reference to FIG. 6.

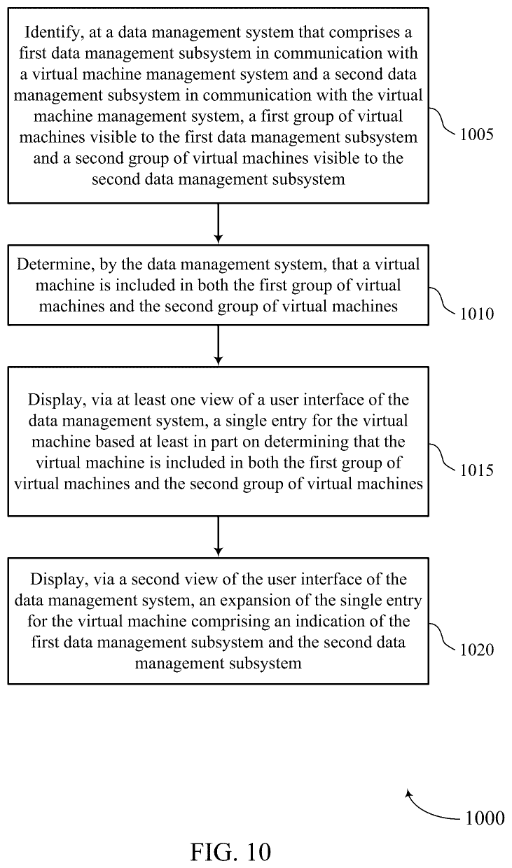

FIG. 10 shows a flowchart illustrating a method 1000 that supports management of duplicative virtual machine entries for a data management system in accordance with aspects of the present disclosure. The operations of the method 1000 may be implemented by a data manager or its components as described herein. For example, the operations of the method 1000 may be performed by a data manager as described with reference to FIGS. 1 through 7. In some examples, a data manager may execute a set of instructions to control the functional elements of the data manager to perform the described functions. Additionally, or alternatively, the data manager may perform aspects of the described functions using special-purpose hardware.

At 1005, the method may include identifying, at a data management system that includes a first data management subsystem in communication with a virtual machine management system and a second data management subsystem in communication with the virtual machine management system, a first group of virtual machines visible to the first data management subsystem and a second group of virtual machines visible to the second data management subsystem. The operations of 1005 may be performed in accordance with examples as disclosed herein. In some examples, aspects of the operations of 1005 may be performed by a data management subsystem identification component 625 as described with reference to FIG. 6.

At 1010, the method may include determining, by the data management system, that a virtual machine is included in both the first group of virtual machines and the second group of virtual machines. The operations of 1010 may be performed in accordance with examples as disclosed herein. In some examples, aspects of the operations of 1010 may be performed by a virtual machine identification component 630 as described with reference to FIG. 6.

At 1015, the method may include displaying, via at least one view of a user interface of the data management system, a single entry for the virtual machine based on determining that the virtual machine is included in both the first group of virtual machines and the second group of virtual machines. The operations of 1015 may be performed in accordance with examples as disclosed herein. In some examples, aspects of the operations of 1015 may be performed by a display component 635 as described with reference to FIG. 6.

At 1020, the method may include displaying, via a second view of the user interface of the data management system, an expansion of the single entry for the virtual machine including an indication of the first data management subsystem and the second data management subsystem. The operations of 1020 may be performed in accordance with examples as disclosed herein. In some examples, aspects of the operations of 1020 may be performed by a display component 635 as described with reference to FIG. 6.

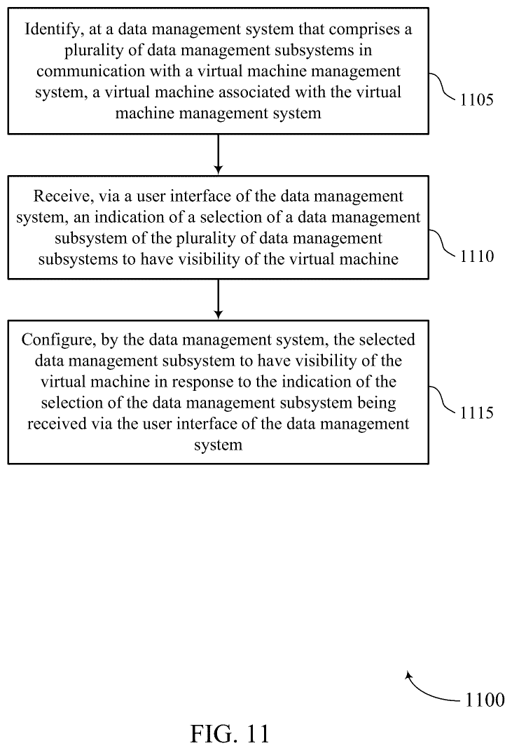

FIG. 11 shows a flowchart illustrating a method 1100 that supports management of duplicative virtual machine entries for a data management system in accordance with aspects of the present disclosure. The operations of the method 1100 may be implemented by a data manager or its components as described herein. For example, the operations of the method 1100 may be performed by a data manager as described with reference to FIGS. 1 through 7. In some examples, a data manager may execute a set of instructions to control the functional elements of the data manager to perform the described functions. Additionally, or alternatively, the data manager may perform aspects of the described functions using special-purpose hardware.

At 1105, the method may include identifying, at a data management system that includes a set of multiple data management subsystems in communication with a virtual machine management system, a virtual machine associated with the virtual machine management system. The operations of 1105 may be performed in accordance with examples as disclosed herein. In some examples, aspects of the operations of 1105 may be performed by a data management subsystem identification component 625 as described with reference to FIG. 6.

At 1110, the method may include receiving, via a user interface of the data management system, an indication of a selection of a data management subsystem of the set of multiple data management subsystems to have visibility of the virtual machine. The operations of 1110 may be performed in accordance with examples as disclosed herein. In some examples, aspects of the operations of 1110 may be performed by a data management subsystem identification component 625 as described with reference to FIG. 6.

At 1115, the method may include configuring, by the data management system, the selected data management subsystem to have visibility of the virtual machine in response to the indication of the selection of the data management subsystem being received via the user interface of the data management system. The operations of 1115 may be performed in accordance with examples as disclosed herein. In some examples, aspects of the operations of 1115 may be performed by a display component 635 as described with reference to FIG. 6.

A method for managing virtual machines is described. The method may include identifying, at a data management system that includes a first data management subsystem in communication with a virtual machine management system and a second data management subsystem in communication with the virtual machine management system, a first group of virtual machines visible to the first data management subsystem and a second group of virtual machines visible to the second data management subsystem, determining, by the data management system, that a virtual machine is included in both the first group of virtual machines and the second group of virtual machines, and displaying, via at least one view of a user interface of the data management system, a single entry for the virtual machine based on determining that the virtual machine is included in both the first group of virtual machines and the second group of virtual machines.

An apparatus for managing virtual machines is described. The apparatus may include a processor, memory coupled with the processor, and instructions stored in the memory. The instructions may be executable by the processor to cause the apparatus to identify, at a data management system that includes a first data management subsystem in communication with a virtual machine management system and a second data management subsystem in communication with the virtual machine management system, a first group of virtual machines visible to the first data management subsystem and a second group of virtual machines visible to the second data management subsystem, determine, by the data management system, that a virtual machine is included in both the first group of virtual machines and the second group of virtual machines, and display, via at least one view of a user interface of the data management system, a single entry for the virtual machine based on determining that the virtual machine is included in both the first group of virtual machines and the second group of virtual machines.

Another apparatus for managing virtual machines is described. The apparatus may include means for identifying, at a data management system that includes a first data management subsystem in communication with a virtual machine management system and a second data management subsystem in communication with the virtual machine management system, a first group of virtual machines visible to the first data management subsystem and a second group of virtual machines visible to the second data management subsystem, means for determining, by the data management system, that a virtual machine is included in both the first group of virtual machines and the second group of virtual machines, and means for displaying, via at least one view of a user interface of the data management system, a single entry for the virtual machine based on determining that the virtual machine is included in both the first group of virtual machines and the second group of virtual machines.

A non-transitory computer-readable medium storing code for managing virtual machines is described. The code may include instructions executable by a processor to identify, at a data management system that includes a first data management subsystem in communication with a virtual machine management system and a second data management subsystem in communication with the virtual machine management system, a first group of virtual machines visible to the first data management subsystem and a second group of virtual machines visible to the second data management subsystem, determine, by the data management system, that a virtual machine is included in both the first group of virtual machines and the second group of virtual machines, and display, via at least one view of a user interface of the data management system, a single entry for the virtual machine based on determining that the virtual machine is included in both the first group of virtual machines and the second group of virtual machines.

Some examples of the method, apparatuses, and non-transitory computer-readable medium described herein may further include operations, features, means, or instructions for determining, for the user interface, a first entry for the virtual machine corresponding to the first group of virtual machines and a second entry for the virtual machine corresponding to the second group of virtual machines and determining that one of the first entry or the second entry corresponds to an active entry of the virtual machine, where displaying the single entry for the virtual machine includes displaying the active entry for the virtual machine.

Some examples of the method, apparatuses, and non-transitory computer-readable medium described herein may further include operations, features, means, or instructions for identifying, in response to determining the first entry and the second entry, a first set of configurations associated with the first entry for the virtual machine and a second set of configurations associated with the second entry for the virtual machine, where determining that the one of the first entry or the second entry corresponds to an active entry of the virtual machine may be based on the first set of configurations and the second set of configurations.

In some examples of the method, apparatuses, and non-transitory computer-readable medium described herein, one of the first set of configurations or the second set of configurations includes an active service level agreement, and the active entry may be associated with the one of the first set of configurations or the second set of configurations that includes the active service level agreement.

Some examples of the method, apparatuses, and non-transitory computer-readable medium described herein may further include operations, features, means, or instructions for displaying, via a second view of the user interface of the data management system, an expansion of the single entry for the virtual machine including an indication of the first data management subsystem and the second data management subsystem.

Some examples of the method, apparatuses, and non-transitory computer-readable medium described herein may further include operations, features, means, or instructions for displaying, via a second view of the user interface of the data management system, an expansion of the single entry for the virtual machine including an indication of a data management subsystem that may be actively managing the virtual machine.

Some examples of the method, apparatuses, and non-transitory computer-readable medium described herein may further include operations, features, means, or instructions for receiving, via a second view of the user interface of the data management system, a user input to select the first data management subsystem or the second data management subsystem for one or more operations and initiating the one or more operations on the selected data management subsystem in response to receiving the user input.

In some examples of the method, apparatuses, and non-transitory computer-readable medium described herein, the one or more operations include at least one of capturing an on-demand snapshot, managing protection of a set of multiple virtual machines, initiating a live mount, or a combination thereof.

Some examples of the method, apparatuses, and non-transitory computer-readable medium described herein may further include operations, features, means, or instructions for initiating a periodic backend job to determine that that the virtual machine is included in both the first group of virtual machines and the second group of virtual machines.

In some examples of the method, apparatuses, and non-transitory computer-readable medium described herein, operations, features, means, or instructions for determining that the virtual machine is included in both the first group of virtual machines and the second group of virtual machines may include operations, features, means, or instructions for determining that a first group of virtual machine identifiers associated with the first group of virtual machines and a second group of virtual machine identifiers associated with the second group of virtual machines both include a virtual machine identifier associated with the virtual machine.

In some examples of the method, apparatuses, and non-transitory computer-readable medium described herein, the first data management subsystem includes a first cluster of storage nodes and the second data management subsystem includes a second cluster of storage nodes.

A method for managing virtual machines is described. The method may include identifying, at a data management system that includes a set of multiple data management subsystems in communication with a virtual machine management system, a virtual machine associated with the virtual machine management system, receiving, via a user interface of the data management system, an indication of a selection of a data management subsystem of the set of multiple data management subsystems to have visibility of the virtual machine, and configuring, by the data management system, the selected data management subsystem to have visibility of the virtual machine in response to the indication of the selection of the data management subsystem being received via the user interface of the data management system.

An apparatus for managing virtual machines is described. The apparatus may include a processor, memory coupled with the processor, and instructions stored in the memory. The instructions may be executable by the processor to cause the apparatus to identify, at a data management system that includes a set of multiple data management subsystems in communication with a virtual machine management system, a virtual machine associated with the virtual machine management system, receive, via a user interface of the data management system, an indication of a selection of a data management subsystem of the set of multiple data management subsystems to have visibility of the virtual machine, and configure, by the data management system, the selected data management subsystem to have visibility of the virtual machine in response to the indication of the selection of the data management subsystem being received via the user interface of the data management system.

Another apparatus for managing virtual machines is described. The apparatus may include means for identifying, at a data management system that includes a set of multiple data management subsystems in communication with a virtual machine management system, a virtual machine associated with the virtual machine management system, means for receiving, via a user interface of the data management system, an indication of a selection of a data management subsystem of the set of multiple data management subsystems to have visibility of the virtual machine, and means for configuring, by the data management system, the selected data management subsystem to have visibility of the virtual machine in response to the indication of the selection of the data management subsystem being received via the user interface of the data management system.

A non-transitory computer-readable medium storing code for managing virtual machines is described. The code may include instructions executable by a processor to identify, at a data management system that includes a set of multiple data management subsystems in communication with a virtual machine management system, a virtual machine associated with the virtual machine management system, receive, via a user interface of the data management system, an indication of a selection of a data management subsystem of the set of multiple data management subsystems to have visibility of the virtual machine, and configure, by the data management system, the selected data management subsystem to have visibility of the virtual machine in response to the indication of the selection of the data management subsystem being received via the user interface of the data management system.

In some examples of the method, apparatuses, and non-transitory computer-readable medium described herein, another data management subsystem of the set of multiple data management subsystems does not may have visibility of the virtual machine based on not being the selected data management subsystem.

Some examples of the method, apparatuses, and non-transitory computer-readable medium described herein may further include operations, features, means, or instructions for receiving, via the user interface of the data management system, an indication of a selection of a second data management subsystem of the set of multiple data managements subsystems to may have visibility of the virtual machine and configuring, by the data management system, the second data management subsystem to may have visibility of the virtual machine in response to the indication of the selection of the second data management subsystem being received via the user interface of the data management system.

In some examples of the method, apparatuses, and non-transitory computer-readable medium described herein, operations, features, means, or instructions for receiving the indication of the selection of the data management subsystem and receiving the indication of the selection of the second data management subsystem may include operations, features, means, or instructions for receiving an indication of a selection of a group of data management subsystems to may have visibility of the virtual machine, the group of data management subsystems including the data management subsystem and the second data management subsystem.

In some examples of the method, apparatuses, and non-transitory computer-readable medium described herein, the set of multiple data management subsystems include a set of multiple clusters of storage nodes.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for managing virtual machines, comprising:
identifying, at a data management system that comprises a first data management subsystem in communication with a virtual machine management system and a second data management subsystem in communication with the virtual machine management system, a first group of virtual machines visible to the first data management subsystem and a second group of virtual machines visible to the second data management subsystem;
determining, by the data management system, that a virtual machine is included in both the first group of virtual machines and the second group of virtual machines; and
displaying, via at least one view of a user interface of the data management system, a single entry for the virtual machine based at least in part on determining that the virtual machine is included in both the first group of virtual machines and the second group of virtual machines.

2. The method of claim 1, further comprising:
determining, for the user interface, a first entry for the virtual machine corresponding to the first group of virtual machines and a second entry for the virtual machine corresponding to the second group of virtual machines; and
determining that one of the first entry or the second entry corresponds to an active entry of the virtual machine, wherein displaying the single entry for the virtual machine comprises displaying the active entry for the virtual machine.

3. The method of claim 2, further comprising:
identifying, in response to determining the first entry and the second entry, a first set of configurations associated with the first entry for the virtual machine and a second set of configurations associated with the second entry for the virtual machine, wherein determining that the one of the first entry or the second entry corresponds to an active entry of the virtual machine is based at least in part on the first set of configurations and the second set of configurations.

4. The method of claim 3, wherein:
one of the first set of configurations or the second set of configurations includes an active service level agreement; and
the active entry is associated with the one of the first set of configurations or the second set of configurations that includes the active service level agreement.

5. The method of claim 1, further comprising:
displaying, via a second view of the user interface of the data management system, an expansion of the single entry for the virtual machine comprising an indication of the first data management subsystem and the second data management subsystem.

6. The method of claim 1, further comprising:
displaying, via a second view of the user interface of the data management system, an expansion of the single entry for the virtual machine comprising an indication of a data management subsystem that is actively managing the virtual machine.

7. The method of claim 1, further comprising:
receiving, via a second view of the user interface of the data management system, a user input to select the first data management subsystem or the second data management subsystem for one or more operations; and
initiating the one or more operations on the selected data management subsystem in response to receiving the user input.

8. The method of claim 7, wherein the one or more operations comprise at least one of capturing an on-demand snapshot, managing protection of a plurality of virtual machines, initiating a live mount, or a combination thereof.

9. The method of claim 1, further comprising:
initiating a periodic backend job to determine that that the virtual machine is included in both the first group of virtual machines and the second group of virtual machines.

10. The method of claim 1, wherein determining that the virtual machine is included in both the first group of virtual machines and the second group of virtual machines comprises:
determining that a first group of virtual machine identifiers associated with the first group of virtual machines and a second group of virtual machine identifiers associated with the second group of virtual machines both include a virtual machine identifier associated with the virtual machine.

11. The method of claim 1, wherein the first data management subsystem comprises a first cluster of storage nodes and the second data management subsystem comprises a second cluster of storage nodes.

12. A method for managing virtual machines, comprising:
identifying, at a data management system that comprises a plurality of data management subsystems in communication with a virtual machine management system, a virtual machine associated with the virtual machine management system;
receiving, via a user interface of the data management system, an indication of a selection of a data management subsystem of the plurality of data management subsystems to have visibility of the virtual machine; and
configuring, by the data management system, the selected data management subsystem to have visibility of the virtual machine in response to the indication of the selection of the data management subsystem being received via the user interface of the data management system.

13. The method of claim 12, wherein another data management subsystem of the plurality of data management subsystems does not have visibility of the virtual machine based at least in part on not being the selected data management subsystem.

14. The method of claim 13, further comprising:
receiving, via the user interface of the data management system, an indication of a selection of a second data management subsystem of the plurality of data managements subsystems to have visibility of the virtual machine; and
configuring, by the data management system, the second data management subsystem to have visibility of the virtual machine in response to the indication of the selection of the second data management subsystem being received via the user interface of the data management system.

15. The method of claim 14, wherein receiving the indication of the selection of the data management subsystem and receiving the indication of the selection of the second data management subsystem comprises:
receiving an indication of a selection of a group of data management subsystems to have visibility of the virtual machine, the group of data management subsystems comprising the data management subsystem and the second data management subsystem.

16. The method of claim 12, wherein the plurality of data management subsystems comprise a plurality of clusters of storage nodes.

17. An apparatus for managing virtual machines, comprising:
a processor;
memory coupled with the processor; and
instructions stored in the memory and executable by the processor to cause the apparatus to:
identify, at a data management system that comprises a first data management subsystem in communication with a virtual machine management system and a second data management subsystem in communication with the virtual machine management system, a first group of virtual machines visible to the first data management subsystem and a second group of virtual machines visible to the second data management subsystem;
determine, by the data management system, that a virtual machine is included in both the first group of virtual machines and the second group of virtual machines; and
display, via at least one view of a user interface of the data management system, a single entry for the virtual machine based at least in part on determining that the virtual machine is included in both the first group of virtual machines and the second group of virtual machines.

18. The apparatus of claim 17, wherein the instructions are further executable by the processor to cause the apparatus to:
determine, for the user interface, a first entry for the virtual machine corresponding to the first group of virtual machines and a second entry for the virtual machine corresponding to the second group of virtual machines; and
determine that one of the first entry or the second entry corresponds to an active entry of the virtual machine, wherein, to display the single entry for the virtual machine, the instructions are further executable by the processor to cause the apparatus to display the active entry for the virtual machine.

19. An apparatus for managing virtual machines, comprising:
a processor;
memory coupled with the processor; and
instructions stored in the memory and executable by the processor to cause the apparatus to:
identify, at a data management system that comprises a plurality of data management subsystems in communication with a virtual machine management system, a virtual machine associated with the virtual machine management system;
receive, via a user interface of the data management system, an indication of a selection of a data management subsystem of the plurality of data management subsystems to have visibility of the virtual machine; and
configure, by the data management system, the selected data management subsystem to have visibility of the virtual machine in response to the indication of the selection of the data management subsystem being received via the user interface of the data management system.

20. The apparatus of claim 19, wherein the instructions are further executable by the processor to cause the apparatus to:
cause another data management subsystem of the plurality of data management subsystems to not have visibility of the virtual machine based at least in part on the other data management subsystem not being the selected data management subsystem.
